(19) United States
(12) Patent Application Publication
(10) Pub. No.: US 2014/0021244 A1
(43) Pub. Date: Jan. 23, 2014

(54) Method of Manufacturing Coil Tubing Using Friction Stir Welding

(71) Applicant: Global Tubing LLC, Dayton, TX (US)

(72) Inventor: Jon D. DuBois, Dayton, TX (US)

(21) Appl. No.: 13/914,209

(22) Filed: Jun. 10, 2013

Related U.S. Application Data
(63) Continuation of application No. 13/653,520, filed on Oct. 17, 2012, now abandoned.
Application No. 13/653,520 is a continuation of application No. 13/408,184, filed on Feb. 29, 2012, now abandoned.
Application No. 13/408,184 is a continuation of application No. 13/183,894, filed on Jul. 15, 2011, now abandoned.
Application No. 13/183,894 is a continuation of application No. 12/961,059, filed on Dec. 6, 2010, now abandoned.
Application No. 12/961,059 is a continuation of application No. 12/767,104, filed on Apr. 26, 2010, now abandoned.
Application No. 12/767,104 is a continuation of application No. 12/576,351, filed on Oct. 9, 2009, now abandoned.
Application No. 12/576,351 is a continuation of application No. 12/414,366, filed on Mar. 30, 2009, now abandoned.

(51) Int. Cl. B23K 20/00; B23K 20/12

(52) U.S. Cl. CPC B23K 20/002; B23K 20/122
USPC 228/112.1

(57) ABSTRACT

A method of manufacturing coiled tubing comprises joining two portions of parent stock metal by friction stir welding. The adjoining portions of said two portions of parent stock metal are first reduced to a deformable plastic state, and then allowed to cool in such a manner that there is no re-crystallization of parent stock metal in a resulting weld.

### BACKGROUND OF THE INVENTION

1. Field of the Invention

Embodiments of the invention generally relate to a method of manufacturing coil tubing using friction stir welding.

2. Description of the Related Art

Coiled steel tubing is used in the oil and gas industry for many applications in the drilling and workover areas. The tubing is produced in a continuous milling operation that utilizes coiled strip of the appropriate width to make the correct diameter of tube. These strips are joined or welded together by a process that causes the metal to be melted or liquefied and filler metal or wire is necessary to be added to the weld puddle to provide a suitable weld.

These welded strips are then run continuously through the ERW tube mill to produce a “string” of tubing that can be as much as 20,000 feet long. The welded string is then placed on a large truck that sets up over the well and the tubing is reeled repeatedly in and out of the well as various fluids and acids are pumped through the tube.

The 20,000 foot string can have as many as 15-20 strip welds that were made to make up the 20,000 foot string. As the tubing is forced in and out of the well, it is repeatedly coiled and uncoiled on the truck reel and the wall of the tubing is repeatedly stressed as the tubing is bent and has a high internal pressure.

The welded strip joint has always been the weak link in this process. If this joint or weld fails or ruptures the results can sometimes be catastrophic. Not only can the tubing fall into the well, and in some cases cannot be removed causing a loss of the well, but fires, explosions, and the like can be life threatening to the operating personnel.

From the mid 1960's many improvements have been made in the material and the configuration of this welded joint that has reduced the failures. However, this joint still remains the weak link today.

The reason this joint is still the weak link is because the welding procedures used still produce the same undesirable characteristics between the weld and the parent material (the strip). Because the joint is an integral part of a continuous length of tubing it is impossible to “heat treat” or cause the welded joint to become like the parent material in common accepted practices today without some change in the physical properties of the parent material or strip at that point.

These variations in the strip at the welded joint can be reduced or eliminated by the application of the friction stir welding process to the joining of the strips to make the string of tubing and to the joining or welding of the finished tube-to-tube products.

### SUMMARY OF THE INVENTION

Embodiments of the invention relate to a method of manufacturing coiled tubing that comprises joining two portions of parent stock metal by friction stir welding. The adjoining portions of said two portions of parent stock metal are first reduced to a deformable plastic state, and then allowed to cool in such a manner that there is no re-crystallization of parent stock metal in a resulting weld.

### DETAILED DESCRIPTION

The friction stir welding process is very unique in that the “weld” or puddle between the two pieces being joined is created by the friction of the tool as it is forced through the parent material in a circular motion. The material only reaches the plastic state and therefore there is no re-crystallization in the weld.

The advantages of Friction Stir Welding (FSW) applied to the welding or joining of the flat strip to produce coiled tubing is as follows:

1. Because there is no melting of the material in the weld bead, and therefore no re-crystallization, the heat affected zone of the weld is practically eliminated. This heat affected zone in the prior art is always the failure point.

2. Because there is no melting there is also no chemical discontinuity or change in the weld zone in relation to the parent material.

3. There is no need to add filler wire causing a chemical discontinuity also.

4. Because there is no melting or re-crystallization there is a very minimum amount of grain change from the parent material.

5. The hardness variation across the weld in parent material in friction stir welding is of little difference and very uniform, thereby eliminating the need to post-heat-treat the weld as in the prior art today.

6. In the current practice, small tabs must be welded manually to the edge of the strip to produce the bias weld used today. The welding of these tabs to the strip edges produces discontinuity at this point that results in joint failures. The FSW process does not require the tabs to be welded to the strip, only held in place.

7. The FSW process is so repeatable and reliable that “welder certification” is not required even in the high tech aerospace industry where this application is used extensively.

8. The FSW process allows different types of metals to be joined together i.e. steel to titanium, aluminum, etc. This is impossible with the welding technology used today in the manufacture of coiled tubing.

While the foregoing is directed to embodiments of the invention, other and further embodiments of the invention may be devised without departing from the basic scope thereof, and the scope thereof is determined by the claims that follow.

1. A method of manufacturing coiled tubing, said method comprising:
joining two portions of parent stock metal by friction stir welding so that adjoining portions of said two portions of parent stock metal are first reduced to a deformable plastic state, and then allowed to cool in such a manner that there is no recrystalization of parent stock metal in a resulting weld.
